(19) United States
(12) Patent Application Publication
(10) Pub. No.: US 2007/0111624 A1
(43) Pub. Date: May 17, 2007

(54) Breathable warm-keeping fabric

(75) Inventors: Chung-Hu Hsiao, Taichung City (TW); Den-Yong Lin, Taichung County (TW); Ching-Hsi Jen, Taichung City (TW)

Correspondence Address: BROWDY AND NEIMARK, P.L.L.C.;624 NINTH STREET, NW, SUITE 300, WASHINGTON, DC, 20001-5303, US

(73) Assignee: Tiong Liong Industrial Co. Ltd., Taichung Hsien (TW)

(21) Appl. No.: 11/272,776

(22) Filed: Nov. 15, 2005

(51) Int. Cl. D03D 15/00; B32B 15/14; D04H 13/00

(52) U.S. Cl. 442/228; 442/238; 442/376

(57) ABSTRACT

A breathable warm-keeping fabric, which includes a base layer prepared from cotton, nylon or polyester, a covering layer prepared from cotton, nylon or polyester, and an aluminum film layer, which is sandwiched between the base layer and the covering layer and prepared from an aluminum mixture, which contains a part of aluminum powder, a part of an assistant, and part of TPU (Thermoplastic Polyurethane), PU (Polyurethane), TPE (Thermoplastic Polyester Elastomer) or PE (Polyester).

### BACKGROUND OF THE INVENTION

1. Field of the Invention

The present invention relates to a warm-keeping compound material and more particularly, to a breathable warm-keeping fabric.

2. Description of the Related Art

A fabric may be covered with a layer of warm-keeping cotton sheet material to provide a warm-keeping effect. However, the warm-keeping cotton sheet material cannot effectively isolate dispersion of thermal energy. Further, in order to enhance the warm-keeping effect, the warn-keeping cotton sheet material must be made relative thicker. However, increasing the thickness of the warm-keeping cotton sheet material relatively lowers the breathing power of the warm-keeping cotton sheet material. It is uncomfortable to wear a heavy cloth made of a fabric having a thick warm-keeping cotton sheet material.

### SUMMARY OF THE INVENTION

The present invention has been accomplished under the circumstances in view. It is the main object of the present invention to provide a breathable warm-keeping fabric, which has thin, light, flexible, breathable, warm-keeping, waterproof and aluminum film characteristics.

To achieve this and other objects of the present invention, the breathable warm-keeping fabric comprises a base layer prepared from cotton, nylon or polyester, a covering layer prepared from cotton, nylon or polyester, and an aluminum film layer sandwiched between the base layer and the covering layer. The aluminum film layer is prepared from an aluminum mixture, which contains a part of aluminum powder, a part of an assistant, and part of TPU (Thermoplastic Polyurethane), PU (Polyurethane), TPE (Thermoplastic Polyester Elastomer) or PE (Polyester).

### BRIEF DESCRIPTION OF THE DRAWINGS

FIG. 1 is a sectional view of a breathable warm-keeping fabric according to a first embodiment of the present invention.

FIG. 2 is a sectional view of a breathable warm-keeping fabric according to a second embodiment of the present invention.

### DETAILED DESCRIPTION OF THE INVENTION

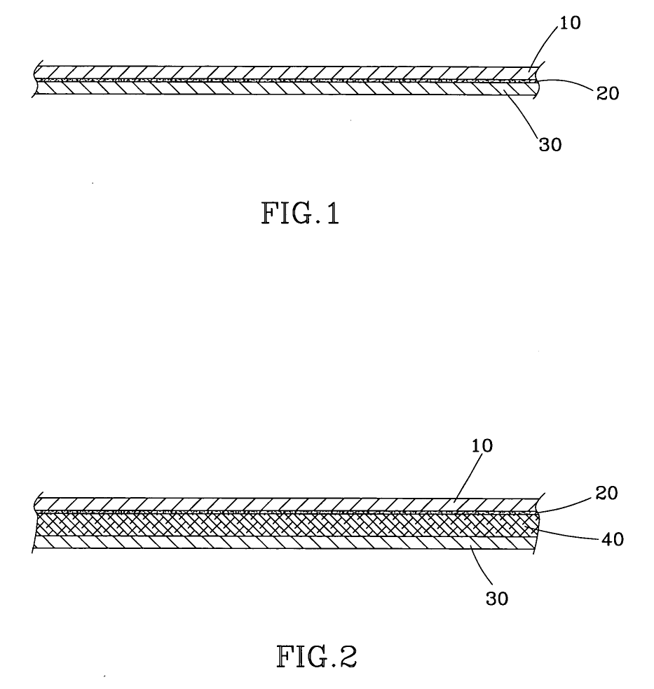

Referring to FIG. 1, a breathable warm-keeping fabric in accordance with the first embodiment of the present invention is shown comprising a base layer 10, a covering layer 30, and an aluminum film layer 20 sandwiched between the base layer 10 and the covering layer 30.

The base layer 10 is a sheet member made of cotton, nylon, or polyester.

The aluminum film layer 20 is a thin film is prepared from an aluminum mixture, and covered on one side of the base layer 10 by bonding, spray-coating, or printing. The aluminum mixture is obtained by mixing a certain amount of aluminum powder with an assistant and TPU (Thermoplastic Polyurethane), PU (Polyurethane), TPE (Thermoplastic Polyester Elastomer), or PE (Polyester). The amount of the aluminum powder in the aluminum mixture is preferably at about 30%˜50%.

The covering layer 30 is a sheet member made of cotton, nylon or polyester and bonded to one side of the aluminum film layer 20 opposite to the base layer 10.

A breathable warm-keeping fabric made according to this first embodiment has thin, light, flexible, breathable and waterproof characteristics. Further, the aluminum film layer can effectively isolate radiating dispersion of thermal energy and reflect body heat, enhancing the warm-keeping effect of the base layer and the covering layer.

FIG. 2 shows a breathable warm-keeping fabric made according to the second embodiment of the present invention. According to this embodiment, the breathable warm-keeping fabric comprises a base layer 10, a covering layer 30, an aluminum film layer 20 bonded in between the base layer 10 and the covering layer 30, and a warm-keeping cotton layer 40 bonded in between the base layer 10 and the covering layer 30.

The base layer 10 is a sheet member made of cotton, nylon, or polyester.

The aluminum film layer 20 is a thin film is prepared from an aluminum mixture, and covered on one side of the base layer 10 by bonding, painting, or printing. The aluminum mixture is obtained by mixing a certain amount of aluminum powder with an assistant and TPU (Thermoplastic Polyurethane), PU (Polyurethane), TPE (Thermoplastic Polyester Elastomer), or PE (Polyester). The amount of the aluminum powder in the aluminum mixture is preferably at about 30%˜50%.

The warm-keeping cotton layer 40 is bonded to one side of the aluminum film layer 20.

The covering layer 30 is a sheet member made of cotton, nylon or polyester and bonded to one side of the warm-keeping cotton layer 40 opposite to the aluminum film layer 20.

A breathable warm-keeping fabric made according to this second embodiment has thin, light, flexible, breathable and waterproof characteristics. Further, the aluminum film layer can effectively isolate radiating dispersion of thermal energy and reflect body heat, enhancing the warm-keeping effect of the base layer, the warm-keeping cotton layer and the covering layer.

What is claimed is:

1. A breathable warm-keeping fabric comprising:
a base layer prepared from a material selected from one of the materials of cotton, nylon and polyester;
an aluminum film layer covered on said base layer, said aluminum film layer being prepared from an aluminum mixture, said aluminum mixture containing a part of aluminum powder, a part of an assistant, and part of a material selected from one of the materials of TPU (Thermoplastic Polyurethane), PU (Polyurethane), TPE (Thermoplastic Polyester Elastomer) and PE (Polyester);
a covering layer bonded to one side of said aluminum film layer opposite to said base layer, said covering layer being prepared from a material selected from one of the materials of cotton, nylon and polyester

2. The breathable warm-keeping fabric as claimed in claim 1, further comprising a warm-keeping cotton layer bonded between said covering layer and said base layer.

3. The breathable warm-keeping fabric as claimed in claim 1, wherein said aluminum mixture contains 30%˜50% aluminum powders.

4. The breathable warm-keeping fabric as claimed in claim 1, wherein said aluminum film layer is bonded to said base layer.

5. The breathable warm-keeping fabric as claimed in claim 1, wherein said aluminum film layer is spray-coated on said base layer.

6. The breathable warm-keeping fabric as claimed in claim 1, wherein said aluminum film layer is printed on said base layer.
